(19) United States
(12) Patent Application Publication
(10) Pub. No.: US 2006/0015919 A1
(43) Pub. Date: Jan. 19, 2006

(54) System and method for transferring video information

(75) Inventors: Henrik Karppinen, Tampere (FI); Jani Lainema, Tampere (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/890,885

(22) Filed: Jul. 13, 2004

(51) Int. Cl. H04N 7/173; H04N 7/16

(52) U.S. Cl. 725/116; 725/117; 725/146; 725/147

(57) ABSTRACT

A device, system and method for coding and transferring video information. Embodiments of the present invention may be used in three-dimensional video applications. According to embodiments of the present invention, video streams may be obtained and sub-sampled. The sub-sampled video streams may be combined. The sub-sampled, combined video stream may then be transferred to a display system to form a three-dimensional image.

### FIELD OF THE INVENTION

Embodiments of the present invention relate to the field of video coding and transfer and, in particular, to systems and methods for the coding and transfer of three-dimensional (3D) (or stereo-view) video for stereoscopic imaging.

### BACKGROUND

The demand for high quality video imaging on mobile devices continues to grow. Consumers now expect their mobile devices to generate sophisticated graphics and to deliver video imagery at a rate suitable for satisfactory viewing. In addition, many consumers expect capabilities from mobile device displays that rival their home viewing experience.

For example, demand is increasing for 3D video on mobile device displays. In typical 3D video generation, two separate video streams may be coded, one for the left eye of the viewer and one for the right eye of the viewer. These two video streams can be combined to form a 3D video stream. However, the resulting bit-rate of the 3D video stream is typically twice that of an ordinary two-dimensional (2D) video stream because the 3D video stream consists of two separate 2D video streams. Thus, data processing requirements for 3D video have typically been burdensome and has often resulted in poor video performance on mobile devices.

### SUMMARY

According to embodiments of the present invention, a method for transferring a video stream may include obtaining a plurality of video streams; sub-sampling-at least one video stream of the plurality of video streams; and transferring the at least one sub-sampled video stream to a display system. The plurality of video streams may include a first video stream and a second video stream. Sub-sampling at least one video stream of the plurality of video streams may include sub-sampling the first video stream and the second video stream. Also, sub-sampling at least one video stream of the plurality of video streams may include sub-sampling the first video stream only or the second video stream only. Sub-sampling may include horizontal sub-sampling. However, the actual sub-sampling rate is not critical and may vary according to various embodiments of the invention.

The display system may include display circuitry and a display. The method may further include combining the first sub-sampled video stream and the second sub-sampled video stream to form a three-dimensional video stream. The method may further include transferring remaining video streams that have not been sub-sampled to the display system. The display may be a three-dimensional display, such as a parallax barrier display or a lenticular lens display, for example, and may be disposed on a mobile device.

The plurality of video streams may be arranged as separate video streams, as a composite video stream, or as an interlaced video stream. The method may further include transferring a mapping of the at least one sub-sampled video stream to the display system, wherein transferring a mapping comprises transferring a mapping via a Supplemental Enhancement Information message and/or a Picture Order Count tag. The method may further include transferring sub-sampling information relating to the at least one sub-sampled video stream to the display system. Transferring sub-sampling information may include transferring sub-sampling information via a Supplemental Enhancement Information message. The Supplemental Enhancement Information message may be transferred with the at least one sub-sampled video stream. The sub-sampling information may include two one-bit Supplemental Enhancement Information messages.

According to an embodiment of the present invention, a device for obtaining and presenting a video stream may include a storage unit for storing a plurality of video streams; and a processor for retrieving the plurality of video streams from the storage unit. The processor may be configured to sub-sample at least one video stream of the plurality of video streams and transfer the at least one sub-sampled video stream to a display system. The plurality of video streams may include a first video stream and a second video stream.

The processor may be configured to sub-sample the first video stream and the second video stream and to sub-sample horizontally. The processor may be configured to sub-sample at a rate that is equal to number of video streams.

The display system may include display circuitry and a display. The display system may be configured to combine the first sub-sampled video stream and the second sub-sampled video stream to form a three-dimensional video stream. The display may be a three-dimensional display, such as a parallax barrier display, for example, and may be disposed on a mobile device.

The processor may be further configured to transfer a mapping of the at least one sub-sampled video stream to the display system, such as via a Supplemental Enhancement Information message, for example. The processor may be further configured to transfer a Picture Order Count tag to the display system. The processor may be further configured to transfer sub-sampling information relating to the at least one sub-sampled video stream to the display system, such as via a Supplemental Enhancement Information message, for example. The processor may be further configured to transfer the Supplemental Enhancement Information message with the at least one sub-sampled video stream. The sub-sampling information may include two one-bit Supplemental Enhancement Information messages.

The plurality of video streams may include a first video stream and a second video stream. The processing system may be configured to sub-sample the first video stream and the second video stream. The processing system may be configured to combine the first sub-sampled video stream and the second sub-sampled video stream to form a three-dimensional video stream.

Embodiments of the present invention may include a computer program product including a computer useable medium having computer program logic recorded thereon for enabling a processor to transfer a video stream, in which the computer program logic may include an obtaining procedure that enables the processor to transfer a plurality of video streams; a sub-sampling procedure that enables the processor to sub-sample at least one video stream of the plurality of video streams; and a transferring procedure that enables the processor to transfer the at least one sub-sampled video stream to a display system. The plurality of video streams may include a first video stream and a second video stream The computer program logic may also include a combining procedure that enables the processor to cause the first sub-sampled video stream and the second sub-sampled video stream to be combined to form a three-dimensional video stream.

### BRIEF DESCRIPTION OF THE DRAWINGS

A detailed description of embodiments of the invention will be made with reference to the accompanying drawings, wherein like numerals designate corresponding parts in the several figures.

FIG. 1 shows a schematic diagram of a 3D viewing system according to an embodiment of the present invention.

FIG. 2 shows a flowchart of a method to generate a 3D video image according to an embodiment of the present invention.

FIG. 3a shows a picture arranged for separate coding according to an embodiment of the present invention.

FIG. 3b shows a picture arranged for separate coding according to an embodiment of the present invention.

FIG. 3c shows a picture arranged for composite coding according to an embodiment of the present invention.

FIG. 3d shows a picture arranged for interlaced coding according to an embodiment of the present invention.

FIG. 4a shows a full resolution video stream according to an embodiment of the present invention.

FIG. 4b shows a full resolution video stream according to an embodiment of the present invention.

FIG. 4c shows a half resolution video stream according to an embodiment of the present invention.

FIG. 4d shows a half resolution video stream according to an embodiment of the present invention.

FIG. 4e shows a combined video stream according to an embodiment of the present invention.

### DETAILED DESCRIPTION OF EXEMPLARY EMBODIMENTS

In the following description of preferred embodiments, reference is made to the accompanying drawings, which form a part hereof, and in which is shown by way of illustration specific embodiments in which the invention may be practiced. It is to be understood that other embodiments may be utilized and structural changes may be made without departing from the scope of the preferred embodiments of the present invention.

Embodiments of the present invention may be used in a variety of applications. For example, embodiments of the present invention may be used for stereoscopic 3D video coding and transfer. Embodiments of the present invention may also be used with a variety of display technologies. Although the following discussion describes embodiments of the present invention in connection with a parallax barrier display, such discussion is intended as an example only and should not be viewed in a limiting sense.

In addition, embodiments of the present invention may be used with a variety of devices, such as mobile devices, wireless devices, home entertainment devices, and the like. For example, embodiments of the present invention may be used with mobile telephones having data storage capabilities such as memory, for example, one or more processors, associated circuitry, a display and the like.

Embodiments of the present invention may generate 3D video streams in a variety of ways. For example, according to an embodiment of the present invention, to generate 3D video, two separate video streams may be coded, one for the left eye of a viewer and one for the right eye of a viewer. By displaying the video streams intended for the left eye and the video streams intended for the right eye as a stereographic pair on a screen or display, each eye may see only the video frame or stream intended for it. The viewer's brain can then combine the video frames, causing the viewer to perceive the video frames as a 3D representation.

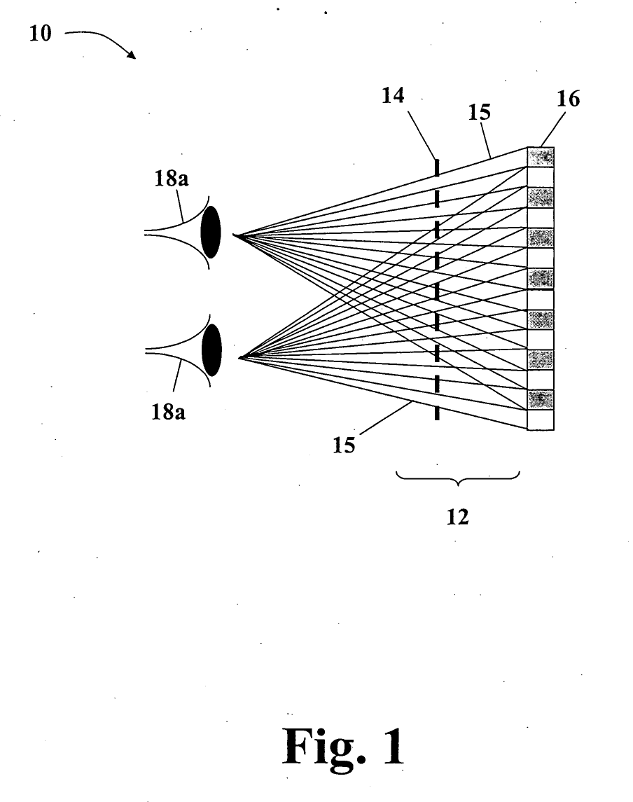

FIG. 1 shows a schematic diagram of a 3D viewing system 10 according to an embodiment of the present invention. The 3D viewing system 10 of FIG. 1 includes, without limitation, a display system 12 that generates images for a viewer's left eye 18a and right eye 18b. The control of light paths to a viewer's eyes may be implemented in a variety of ways. For example, the control of light paths may be implemented with a mask, such as in a parallax barrier display, for example, or with a lens, such as in a lenticular lens display, for example. In FIG. 1, the display system 12 displays a video stream 16 and includes a parallax barrier 14 and one or more light paths 15. In FIG. 1, a 3D effect is generated by controlling the light paths 15 from the display system 12 to the viewer's eyes so that slightly different images reach the viewer's left eye 18a and right eye 18b. The parallax barrier 14 controls the light paths 15 and separates the display system 12 images so that different images reach the left and right eyes; thus, the left eye 18a sees only the images intended for it and the right eye 18b sees only the images intended for it. By displaying the image intended for the left eye 18a and the image intended for the right eye 18b as a stereographic pair on a screen, each eye sees only the image intended for it and the brain combines the images and perceives them as a 3D representation. Thus, a parallax barrier display requires no special viewing glasses to generate 3D images.

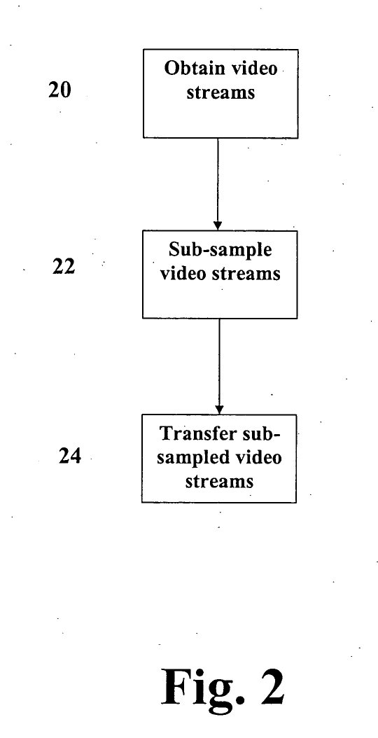

FIG. 2 shows a flowchart of a method to generate a 3D video image according to an embodiment of the present invention. The method shown in FIG. 2 may be used with a variety of display technologies, such as the parallax display shown in FIG. 1, for example. At step 20, video streams are obtained. The video streams may be obtained from various locations within the device on which a display is disposed. For example, if the device on which embodiments of the invention are used is a mobile device with a display, the video streams may be obtained by a processor from memory, a video encoder, or the like.

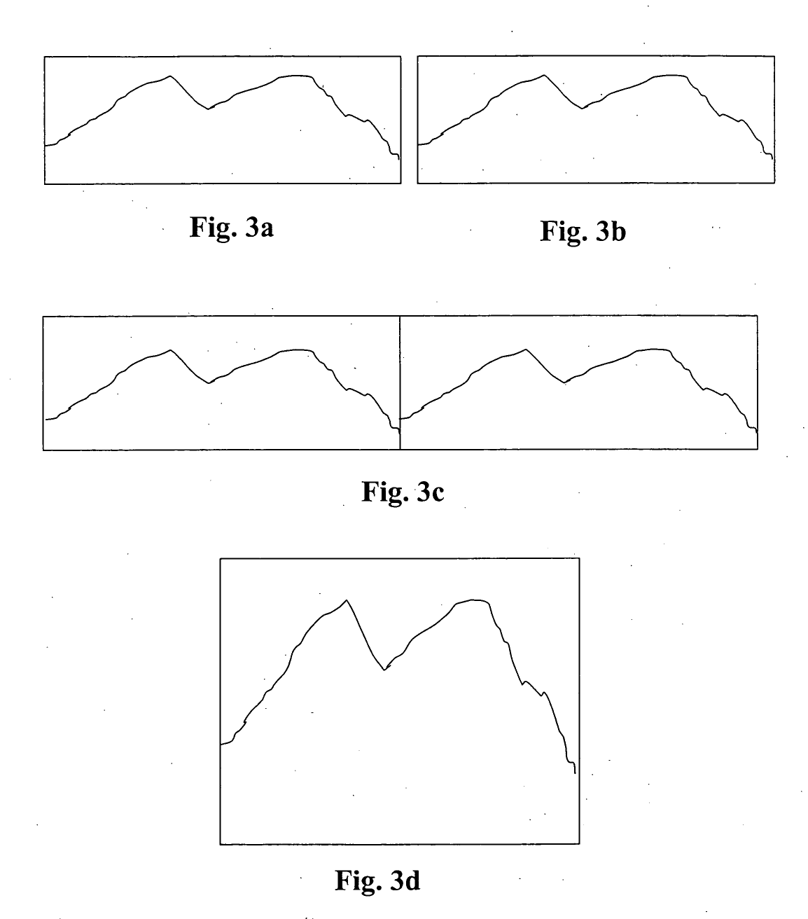

The video streams may be obtained in a variety of configurations. FIGS. 3a-3d show various configurations in which video frames or pictures may be coded according to embodiments of the present invention. FIGS. 3a and 3b show two pictures which may be coded separately to form two separate 2D video streams. FIG. 3c shows the two pictures of FIGS. 3a and 3b as synchronized pictures, grouped together to form a composite picture. The coding of FIG. 3c may reduce the complexity of bit-stream handling.

FIG. 3d shows the two pictures of FIGS. 3a and 3b as an interlaced frame. In FIG. 3d, the pictures of FIG. 3a and FIG. 3b have been interlaced, where the picture of FIG. 3a is the top field and the picture of FIG. 3b is the bottom field. The interlaced pictures of FIG. 3d may be coded in a variety of ways, such as with the methods of the ITU-T H.264 video coding standard, for example. The coding of FIG. 3d may result in improved compression and bit-stream handling.

Returning to FIG. 2, once the video streams have been obtained, the video streams may be sub-sampled at step 22. In the case of a parallax barrier display, because the parallax barrier effectively blocks the viewing of particular pixels in a video stream from reaching either the right eye or the left eye of a viewer, the blocked pixels may be eliminated from the video stream. Sub-sampling the video stream can eliminate pixels from the stream. Sub-sampling may be performed regardless of the how the frames are arranged in the 3D stream. In the case of a parallax barrier display, because only half-resolution left and right view frames are needed in order to form a combined stereo video frame, full resolution streams need not be transferred. The bit-rate and the pixel-processing rate of the video stream may be halved by horizontally sub-sampling every other frame in the video stream.

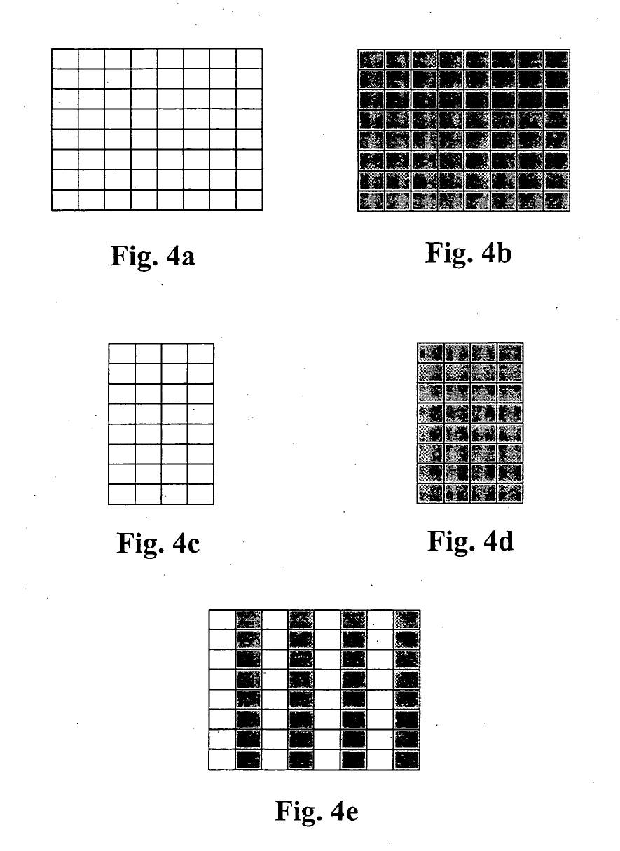

FIGS. 4a-4d show block diagrams of video stream sub-sampling according to an embodiment of the present invention. FIG. 4a shows a first video stream while FIG. 4b shows a second video stream. Each video stream in FIG. 4a and FIG. 4b is a full resolution stream. In the example of FIGS. 4a and 4b, each video stream includes 64 pixels.

FIGS. 4c and 4d show video streams with halved horizontal resolution frames. The video streams in FIGS. 4c and 4d are obtained by sub-sampling the video streams in FIGS. 4a and 4b, respectively. Thus, in the example of FIGS. 4c and 4d, each video stream includes 32 frames, i.e., one-half the number of frames of the video streams in FIGS. 4a and 4b, respectively.

According to embodiments of the present invention, the sub-sampled video streams may also be combined to form a video stream for 3D viewing. FIG. 4d shows the sub-sampled video streams of FIGS. 4c and 4d combined to form a video stream for 3D viewing. The combined video stream in the example of FIG. 4e may be formed by alternately combing each frame of the halved horizontal resolution frames in FIGS. 4c and 4d. The combined video stream in the example of FIG. 4e may be transferred to a 3D display system as will be explained in greater detail below.

Returning to FIG. 2, once the original video streams have been sub-sampled or sub-sampled and combined, the video streams may be transferred to a display system at step 24. According to embodiments of the present invention, to facilitate rendering of the sub-sampled, combined video stream on a display in a 3D format, each frame of the video stream may be mapped and transferred to a display system with sub-sampling information.

The mapping and supplying of sub-sampling information may be implemented in a variety of ways. For example, according to an embodiment of the present invention, Supplemental Enhancement Information (SEI) messages, which are available in the ITU-T H.264 video coding standard, may be utilized in a video stream to carry mapping and sub-sampling information.

According to an embodiment of the present invention, the mapping of frames for alternate viewing by the left eye and right eye may be implemented with a single SEI message and a numbering of the frames or pictures. The pictures may be numbered, for example, by using the Picture Order Count (POC) tags in the ITU-T H.264 standard. The SEI message may then be transmitted along with the video stream to indicate how the pictures with even and odd POC tags are mapped to the left and right view. For example, according to an embodiment of the present invention, a 1-bit message may be called “even_frame_is_left_view flag” and may be interpreted as follows:
Value “1”: All pictures with even POC tags are for the left view All pictures with odd POC tags are for the right view;
Value “0”: All pictures with even POC tags are for the right view All pictures with odd POC tags are for the left view.

Transmission of sub-sampling information can also be implemented in a variety of ways. For example, a horizontally_sub_sampled_frames_flag may be used to transmit sub-sampling information. According to an embodiment of the present invention, if the horizontally_sub_sampled_frames_flag is equal to “1”, one or more input frames may be horizontally sub-sampled by a factor of two. If the horizontally_sub_sampled_frames_flag is equal to “1” and a frame size of the left and right views are equal, then frames from both views may be sub-sampled. If the horizontally_sub_sampled_frames_flag is equal to “1 and the frame size of the left and right views is not equal, then either the left view or the right view frame may have full-resolution and the other view may be sub-sampled by a factor of two, for example.

Also, a 3D video stream with a variable frame size can also be rendered on a 2D display without up-scaling by choosing the full-resolution frames from the stream. For example, if the horizontally_sub_sampled_frames_flag is equal to “0”, the frames are not sub-sampled.

In addition, according to embodiments of the present invention, different sub-sampling combinations may be implemented. For example, sub-sampling information may be implemented with the following two 1-bit SEI messages:
horizonally_sub_sampled_left_view value is “1”: the left view is sub-sampled in the horizontal direction;
horizonally_sub_sampled_right_view value “1”: the right view is sub-sampled in the horizontal direction.

According to embodiments of the present invention, separating the sub-sampling information into two messages permits trade-offs between rendering accuracy for 2D and 3D displays. For example, by sub-sampling both right and left views, a desirable bit-rate for 3D rendering may be achieved in displays using parallax barrier technology. As another example, by sub-sampling only one video stream, the other video stream may be rendered on a 2D display with full accuracy, but bit-rate and processing rate savings may still be obtained for 3D displays since one video stream has been sub-sampled. If neither video stream is sub-sampled, either of the video streams may be rendered on a 2D display with full accuracy.

For example, if a mobile device includes a 2D display, then only one of the left video stream or the right video stream may be decoded from the 3D video stream and shown on the 2D display. If both the left and right video frames have been sub-sampled, horizontal up-sampling of the video stream may be desirable prior to rendering on the 2D display. If only one video stream has been sub-sampled, the video stream that has not been sub-sampled may be rendered at the 2D display with full resolution.

While particular embodiments of the present invention have been shown and described, it will be obvious to those skilled in the art that the invention is not limited to the particular embodiments shown and described and that changes and modifications may be made without departing from the spirit and scope of the appended claims.

What is claimed is:

1. A method for transferring a video stream comprising:
obtaining a plurality of video streams;
sub-sampling at least one video stream of the plurality of video streams; and
transferring the at least one sub-sampled video stream to a display system.

2. The method of claim 1, wherein the plurality of video streams comprises a first video stream and a second video stream.

3. The method of claim 2, wherein sub-sampling at least one video stream of the plurality of video streams comprises sub-sampling the first video stream and sub-sampling the second video stream.

4. The method of claim 2, wherein sub-sampling at least one video stream of the plurality of video streams comprises sub-sampling the first video stream only.

5. The method of claim 2, wherein sub-sampling at least one video stream of the plurality of video streams comprises sub-sampling the second video stream only.

6. The method of claim 1, wherein sub-sampling comprises horizontal sub-sampling.

7. The method of claim 1, wherein a sub-sampled bit rate is one-half a bit rate of the plurality of video streams.

8. The method of claim 1, wherein a sub-sampled bit rate is one-half a pixel-processing rate of the plurality of video streams.

9. The method of claim 1, wherein obtaining the plurality of video streams comprises obtaining the plurality of video streams from a video encoder.

10. The method of claim 1, wherein the display system comprises display circuitry and a display.

11. The method of claim 10, further comprising combining the first sub-sampled video stream and the second sub-sampled video stream to form a three-dimensional video stream.

12. The method of claim 10, further comprising transferring video streams that have not been sub-sampled to the display system.

13. The method of claim 10, wherein the display is a three-dimensional display.

14. The method of claim 10, wherein the display is a parallax barrier display.

15. The method of claim 10, wherein the display is a lenticular lens display.

16. The method of claim 10, wherein the display is disposed on a mobile device.

17. The method of claim 1, wherein the plurality of video streams is arranged as separate video streams.

18. The method of claim 1, wherein the plurality of video streams is arranged as a composite video stream.

19. The method of claim 1, wherein the plurality of video streams is arranged as an interlaced video streams.

20. The method of claim 1, further comprising transferring a mapping of the at least one sub-sampled video stream to the display system.

21. The method of claim 20, wherein transferring a mapping comprises transferring a mapping via a Supplemental Enhancement Information message.

22. The method of claim 21, wherein transferring a mapping further comprises transferring a Picture Order Count tag.

23. The method of claim 20, further comprising transferring sub-sampling information relating to the at least one sub-sampled video stream to the display system.

24. The method of claim 23, wherein transferring sub-sampling information comprises transferring sub-sampling information via a Supplemental Enhancement Information message.

25. The method of claim 24, wherein the Supplemental Enhancement Information message is transferred with the at least one sub-sampled video stream.

26. The method of claim 23, wherein the sub-sampling information comprises two one-bit Supplemental Enhancement Information messages.

27. The method of claim 24, wherein the Supplemental Enhancement Information message indicates that the at least one sub-sampled video stream is horizontally sub-sampled.

28. The method of claim 24, wherein the Supplemental Enhancement Information message indicates that a first view of the at least one sub-sampled video stream and a second view of the at least one sub-sampled video stream are both horizontally sub-sampled by a factor of two when a frame size of the first view and a frame size of the second view are equal.

29. The method of claim 24, wherein the Supplemental Enhancement Information message indicates that only a first view of the at least one sub-sampled video stream or only a second view of the at least one sub-sampled video stream is horizontally sub-sampled by a factor of two when a frame size of the first view is not equal to a frame size of the second view.

30. A device for obtaining and transferring a video stream comprising:
a storage unit for storing a plurality of video streams; and
a processor for retrieving the plurality of video streams from the storage unit,
wherein the processor is configured to
sub-sample at least one video stream of the plurality of video streams; and
transfer the at least one sub-sampled video stream to a display system

31. The device of claim 30, wherein the plurality of video streams comprises a first video stream and a second video stream.

32. The device of claim 31, wherein the processor is configured to sub-sample the first video stream and the second video stream.

33. The device of claim 30, wherein the processor is configured to sub-sample horizontally.

34. The device of claim 30, wherein the processor is configured to sub-sample at a rate that is one-half a bit rate of the plurality of video streams.

35. The device of claim 30, wherein the processor is configured to sub-sample at a rate that is one-half a pixel-processing rate of the plurality of video streams.

36. The device of claim 30, wherein the display system comprises display circuitry and a display.

37. The device of claim 30, wherein the display system is configured to combine the first sub-sampled video stream and the second sub-sampled video stream to form a three-dimensional video stream.

38. The device of claim 36, wherein the display is a three-dimensional display.

39. The device of claim 36, wherein the display is a parallax barrier display.

40. The device of claim 36, wherein the display is a lenticular lens display.

41. The device of claim 36, wherein the display is disposed on a mobile device.

42. The device of claim 30, wherein the processor is further configured to transfer a mapping of the at least one sub-sampled video stream to the display system.

43. The device of claim 42, wherein the processor is further configured to transfer a mapping via a Supplemental Enhancement Information message.

44. The device of claim 43, wherein the processor is further configured to transfer a Picture Order Count tag to the display system.

45. The device of claim 42, wherein the processor is further configured to transfer sub-sampling information relating to the at least one sub-sampled video stream to the display system.

46. The device of claim 43, wherein the processor is further configured to transfer the Supplemental Enhancement Information message with the at least one sub-sampled video stream.

47. The device of claim 45, wherein the sub-sampling information comprises two one-bit Supplemental Enhancement Information messages.

48. The device of claim 43, wherein the Supplemental Enhancement Information message indicates that the at least one sub-sampled video stream is horizontally sub-sampled by a factor of two.

49. The device of claim 43, wherein the Supplemental Enhancement Information message indicates that a first view of the at least one sub-sampled video stream and a second view of the at least one sub-sampled video stream are both horizontally sub-sampled by a factor of two when a frame size of the first view and a frame size of the second view are equal.

50. The device of claim 43, wherein the Supplemental Enhancement Information message indicates that only a first view of the at least one sub-sampled video stream or only a second view of the at least one sub-sampled video stream is horizontally sub-sampled by a factor of two when a frame size of the first view is not equal to a frame size of the second view.

51. A system for transferring a video stream comprising:
a storage system for storing a plurality of video streams; and
a processing system for retrieving the plurality of video streams from the storage unit; and
a display system for displaying video streams,
wherein the processing system is configured to
sub-sample at least one video stream of the plurality of video streams; and
transfer the at least one sub-sampled video stream to the display system.

52. The system of claim 51, wherein the plurality of video streams comprises a first video stream and a second video stream.

53. The system of claim 52, wherein the processing system is configured to sub-sample the first video stream and the second video stream.

54. The system of claim 51, wherein the processing system is configured to sub-sample at a rate that is one-half a bit rate of the plurality of video streams.

55. The system of claim 51, wherein the processing system is configured to sub-sample at a rate that is one-half a pixel-processing rate of the plurality of video streams.

56. The system of claim 51, wherein the display system comprises display circuitry and a display.

57. The system of claim 51, wherein the processing system is configured to combine the first sub-sampled video stream and the second sub-sampled video stream to form a three-dimensional video stream.

58. The system of claim 56, wherein the display is a three-dimensional display.

59. The system of claim 56, wherein the display is a parallax barrier display.

60. The system of claim 56, wherein the display is a lenticular lens display.

61. The system of claim 56, wherein the display is disposed on a mobile device.

62. A computer program product comprising a computer useable medium having computer program logic recorded thereon for enabling a processor to transfer a video stream, the computer program comprising:
an obtaining procedure that enables the processor to transfer a plurality of video streams;
a sub-sampling procedure that enables the processor to sub-sample at least one video stream of the plurality of video streams; and
a transferring procedure that enables the processor to transfer the at least one sub-sampled video stream to a display system.

63. The computer program product of claim 62, wherein the plurality of video streams comprises a first video stream and a second video stream.

64. The computer program product of claim 63, wherein the sub-sampling procedure enables the processor to sub-sample the first video stream and the second video stream.

65. The computer program product of claim 63, wherein the transferring procedure enables the processor to transfer the first video stream and the second video stream.

66. The computer program product of claim 62, wherein the sub-sampling procedure enables the processor to sub-sample at a sub-sampling rate that is one-half a bit rate of the plurality of video streams.

67. The computer program product of claim 62, wherein the sub-sampling procedure enables the processor to sub-sample at a sub-sampling rate that is one-half a pixel-processing rate of the plurality of video streams.

68. The computer program product of claim 63, wherein the sub-sampling procedure enables the processor to sub-sample the first video stream and the second video stream.

69. The computer program product of claim 62, wherein the display system comprises display circuitry and a display.

70. The computer program product of claim 63, further comprising a combining procedure that enables the processor to cause the first sub-sampled video stream and the second sub-sampled video stream to be combined to form a three-dimensional video stream.

71. The computer program product of claim 62, wherein the display is a three-dimensional display.

72. The computer program product of claim 62, wherein the display is a parallax barrier display.

73. The computer program product of claim 62, wherein the display is a lenticular lens display.

74. The computer program product of claim 62, wherein the display is disposed on a mobile device.

75. A system for transferring a video stream comprising:
means for obtaining a plurality of video streams;
means for sub-sampling at least one video stream of the plurality of video streams; and
means for transferring the at least one sub-sampled video stream to a display system.

76. The system of claim 75, wherein the plurality of video streams comprises a first video stream and a second video stream.

77. The system of claim 76, wherein the means for sub-sampling sub-samples the first video stream and the second video stream.

78. The system of claim 75, wherein the means for sub-sampling sub-samples a rate that is one-half a bit rate of the plurality of video streams.

79. The system of claim 75, wherein the means for sub-sampling sub-samples a rate that is one-half a pixel-processing rate of the plurality of video streams.

80. The system of claim 77, further comprising means for combining the first sub-sampled video stream and the second sub-sampled video stream.

81. A device for sending a video stream, comprising:
a processor for:
obtaining at least one video stream;
downsampling the at least one video stream: and
creating a Supplemental Enhancement Information message:
a transmitter configured for sending the at least one video stream and Supplemental Enhancement Information message.

82. A computer program product comprising a computer useable medium having computer program logic recorded thereon for enabling the sending of a video stream, the computer program comprising:
obtaining at least one video stream;
downsampling the at least one video stream;
creating a Supplemental Enhancement Information message; and
sending the at least one video stream and Supplement Enhancement Information message.
